(19) United States
(12) Patent Application Publication
(10) Pub. No.: US 2018/0250902 A1
(43) Pub. Date: Sep. 6, 2018

(54) MANUAL HEAT-PRESS APPARATUSES AND ASSOCIATED METHODS

(71) Applicant: Citta International LLC, Bellevue, WA (US)

(72) Inventors: Jun Yan, Shenzhen (CN); Bo Li, Basking Ridge, NJ (US)

(21) Appl. No.: 15/449,398

(22) Filed: Mar. 3, 2017

(51) Int. Cl. B30B 1/12; B30B 15/06

(52) U.S. Cl. CPC B30B 1/12; B30B 15/064

(57) ABSTRACT

Apparatuses for pressing and heating a material and associated methods are disclosed herein. An apparatus of the present technology includes a handle, a linkage component operably coupled to the handle, a pressure component operably coupled to the linkage component, a first heating component coupled to the pressure component, a second heating component positioned adjacent to the first heating component, and a positioning component positioned adjacent to the linkage component and configured to position the linkage component. The linkage component is movable between a first position and a second position. The positioning component is positioned to maintain the linkage component at the second positon. When the linkage component is at the second position, the linkage component applies a force on the pressure component such that the first heating component coupled to the pressure component is moved toward the second heating component.

### TECHNICAL FIELD

The present technology is directed generally to apparatuses and associated methods for heating and pressing a material. More particularly, the present technology relates to apparatuses that enable a user to manually and effectively control a heat-press process without requiring the user to constantly apply a force thereon.

### BACKGROUND

A heat-press process is an important operation for processing or producing multiple types of agriculture products. Key factors to a successful heat-press process involve proper control of heat and pressure. Manual control of a heat-press process enables a user to continuously monitor the process and also allows the user to precisely control the same. However, conventional manual heat-press devices require a user to continuously apply forces thereon, which can be tiring and inconvenient to the user. Therefore, it would be beneficial to have an improved manual heat-press apparatus to address the above-mentioned problems.

### SUMMARY

The following summary is provided for the convenience of the reader and identifies several representative embodiments of the disclosed technology. Generally speaking, the present technology provides improved apparatuses and methods that enable a user to conveniently and manually perform a heat-press process. More particularly, the present technology provides a manual heat-press apparatus that does not require a user to continuously apply forces thereon during a heat-press process.

In representative embodiments, an apparatus of the present technology includes, for example, (1) a handle, (2) a linkage component operably coupled to the handle, (3) a pressure component operably coupled to the linkage component, (4) a first heating component (an upper heating platen) coupled to the pressure component (e.g., a gas cylinder, a hydraulic cylinder, and/or other suitable devices), (5) a second heating component (e.g., a lower heating platen) positioned adjacent to the first heating component, and (6) a positioning component (e.g., a stopper, a guiding rail, an aligning component, and/or other suitable devices) positioned adjacent to the linkage component and configured to position the linkage component. The first and second heating components can heat opposite sides of a workpiece. In other embodiments, the apparatus includes only one heating platen. The other platen can apply compressive stresses without applying thermal energy,

A user can control the apparatus via the handle. By moving and/or rotating the handle, the linkage component can be moved between a first position and a second position, When the linkage component is at the first position, the apparatus allows the user to put a material to be heat-pressed in the apparatus (or remove a heat-pressed material therefrom). When the linkage component is at the second position, the linkage component can continuously apply a force on the pressure component such that the first heating component coupled to the pressure component is moved toward the second heating component (and accordingly, a material positioned therebetween can be heat-pressed). The user does not need to keep pressing the handle during the whole heat-press process. Rather, once the user manages to have the linkage component move to the second position, then he/she no long needs to keep holding/pressing the handle. The positioning component would maintain the location of the linkage component, and accordingly the pressure component can continuously provide suitable forces on the material to be heat-pressed.

Another aspect of the present technology is to provide a method for manufacturing a heat-press apparatus. In one embodiment, the method includes (1) operably coupling a handle to a linkage component; (2) operably coupling a cylinder component to the linkage component; (3) coupling a first heating component to the cylinder component; (4) positioning a second heating component adjacent to the first heating component; and (5) positioning an aligning component adjacent to the linkage component. The linkage component is movable between a first position and a second position. The linkage component has a first length when the linkage component is at the first position. The linkage component has a second length when the linkage component is at the second position. The second length is greater than the first length. The aligning component is configured to position the linkage component at the second positon. When the linkage component is at the second position, the linkage component applies a force on the cylinder component such that the first heating component, which is coupled to the cylinder component is moved toward the second heating component. Accordingly, a material positioned between the first and second heating components can be heat-pressed.

Yet another aspect of the present technology is to provide a method for operating a heat-press apparatus. In an embodiment, the method includes (1) positioning a linkage component at a first position, the linkage component having a first length when the linkage component is at the first position; and (2) positioning the linkage component at a second position by manually rotating a handle operably coupled to the linkage component, the linkage component having a second length when the linkage component is at the second position, the second length being greater than the first length. When the linkage component is at the second position, the linkage component is in contact with an aligning component positioned adjacent to the linkage component. The aligning component is positioned to support the linkage component. When the linkage component is at the second position, the linkage component applies a force on a cylinder component coupled to the linkage component applies such that a first heating component coupled to the cylinder component is moved toward a second heating component positioned adjacent to the first heating component. In some embodiments, the method can include periodically or continuously monitor the location of the linkage component during the heat-press process.

In some embodiments, the linkage component can include a first linkage member and a second linkage member coupled to the first linkage member. The first linkage member can be coupled to the handle, and the second linkage member can be coupled to the pressure component or the cylinder component. When the linkage component is at the first positon, the first linkage member and the second linkage member together form a non-180-degree angle (e.g., an acute angle, a right angle, or an obtuse angle). When the linkage component is at the second position, the linkage component is in contact with the positioning component (or the aligning component). In such embodiments, the first linkage member and the second linkage member can (e.g., vertically) form a substantially straight line (e.g., a 180-degree angle). At this time, the positioning component or the aligning component can function as a (e.g., horizontal) stopper or a (e.g., horizontal) guiding component to maintain the locations of the first linkage member and the second linkage member (i.e., to keep forming the substantially straight one). By so doing, the first linkage member and the second linkage member can keep pressing the pressure component (or the cylinder component) attached to the second linkage member, such that the pressure component (or the cylinder component) can continuously apply a force on a material to be heat-pressed by the first heating component. Apparatuses and methods in accordance with embodiments of the present technology can include any one or a combination of any of the foregoing elements described above.

### BRIEF DESCRIPTION OF THE DRAWINGS

FIG. 1 is an isometric view of an apparatus configured in accordance with representative embodiments of the disclosed technology.

FIG. 2 is an exploded view of an apparatus configured in accordance with representative embodiments of the disclosed technology.

FIG. 3 is a side view illustrating an apparatus configured in accordance with representative embodiments of the disclosed technology.

FIGS. 4A and 4B are partial, isometric views illustrating operations of an apparatus configured in accordance with representative embodiments of the disclosed technology.

FIG. 5A is an isometric view of an adjustable supporting component and a heating component configured in accordance with representative embodiments of the present technology.

FIG. 5B is a bottom view of an apparatus having the adjustable supporting component and the heating component shown in FIG. 5A.

FIG. 6 is a flowchart illustrating a method in accordance with representative embodiments of the disclosed technology.

FIG. 7 is a flowchart illustrating a method in accordance with representative embodiments of the disclosed technology.

### DETAILED DESCRIPTION

### 1. Overview

The present technology is directed generally to apparatuses and associated methods for heating and pressing a material (e.g., agricultural materials). A representative apparatus can include a handle, a linkage component operably coupled to the handle, a pressure component (e.g., a cylinder, a spring, and/or other suitable components that can provide a continuous force) operably coupled to the linkage component, and a positioning component (or an aligning component) positioned adjacent to the linkage component and configured to position the linkage component. The apparatus further includes a first heating component coupled to the pressure component, and a second heating component positioned adjacent to the first heating component. The material to be heat-pressed can be positioned between the first and second heating components and then is heat-pressed at one or more pre-determined operating conditions. For example, the material can be heat-pressed at a certain temperature (or in some temperature range), under a specific pressure (or in a particular pressure range), and/or for a particular period of time.

The linkage component of the heat-press apparatus is movable between a first position (or a first configuration) and a second position (or a second configuration). A user can manually control the apparatus via the handle to move the linkage component between the first position and the second position. When the linkage component is at the first position, the apparatus allows the user to put the material to be heat-pressed in the apparatus (or remove a heat-pressed material therefrom). The positioning component is positioned to maintain the linkage component at the second positon. When the linkage component is at the second position, the linkage component applies a continuous force on the pressure component such that the first heating component coupled to the pressure component is moved toward the second heating component and then the material can be heat-pressed. The user does not need to keep pressing the handle during the whole heat-press process.

The linkage component can have multiple configurations in different embodiments. In some embodiments, for example, the linkage component can include a first linkage member and a second linkage member that is rotatably coupled to the first linkage member. In some embodiments, the first linkage member and the second linkage member can be coupled by a hinge. In some embodiments, the first linkage member and the second linkage member can be coupled by a gear set. In such embodiments, the gear set can be configured to maintain the location of the first linkage member relative to the second linkage member (e.g., maintain an angle formed by the first linkage member and the second linkage member).

The first linkage member is operably coupled to the handle, and the second linkage member is operably coupled to the pressure component. When the linkage component is at the first positon, the first linkage member and the second linkage member together form a non-180-degree angle (e.g., an acute angle, a right angle, or an obtuse angle). When the linkage component is at the second position, the linkage component is in contact with the positioning component. In such embodiments, the first linkage member and the second linkage member together form a substantially straight line (e.g., a 180-degree angle). In some embodiments, the “180-degree angle” can be an angle slightly smaller than 180 degrees (e.g., 175 degrees). In such cases, the positioning component can function as a stopper or a guiding component to maintain the locations of the first linkage member and the second linkage member (i.e., to keep forming the substantially straight line), By this arrangement, the first linkage member and the second linkage member can keep pressing the pressure component attached to the second linkage member, such that the pressure component can continuously apply a force on a material to be heat-pressed by the first heating component (whereas the second heating component is positioned opposite to the first heating component to support it).

The heat-press apparatuses in accordance with the present technology can provide a user with convenience that he/she doesn't need to keep holding/pressing the handle once the linkage component is set (e.g., at the second positon). In addition, the present technology enables the user to operate the apparatuses in an intuitive and straightforward fashion, which enhances overall efficiency of a heat-press process.

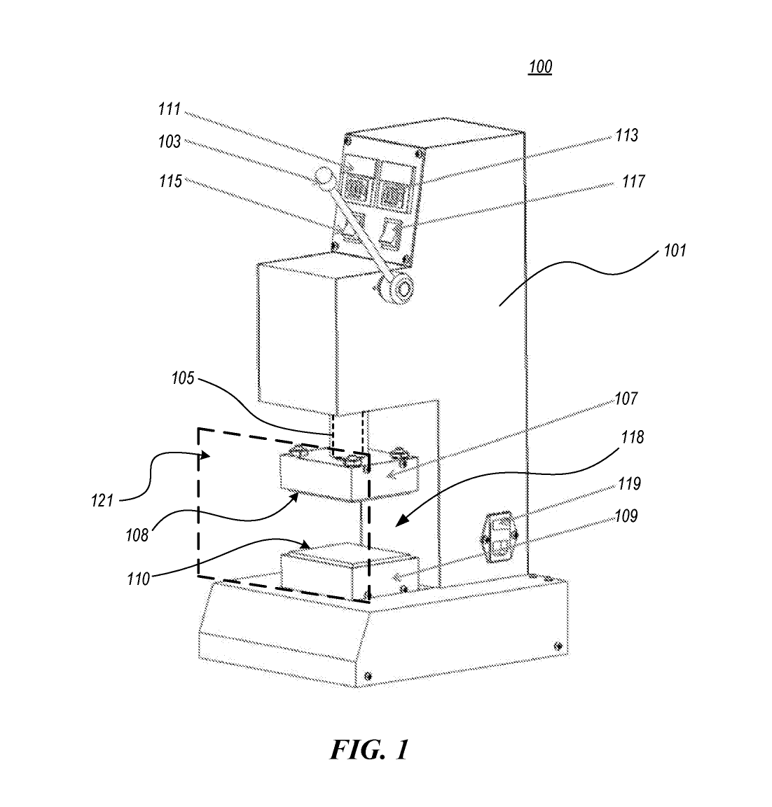

Several details describing structures or processes that are well-known and often associated with heat-press apparatuses and corresponding systems and subsystems, but that may unnecessarily obscure some significant aspects of the disclosed technology, are not set forth in the following description for purposes of clarity. Moreover, although the following disclosure sets forth several embodiments of different aspects of the technology, several other embodiments can have different configurations and/or different components than those described in this section. Accordingly, the technology may have other embodiments with additional elements and/or without several of the elements described below with reference to FIGS. 1-7. FIGS. 1-7 are provided to illustrate representative embodiments of the disclosed technology. Unless provided for otherwise, the drawings are not intended to limit the scope of the claims in the present application.

### 2. Representative Embodiments

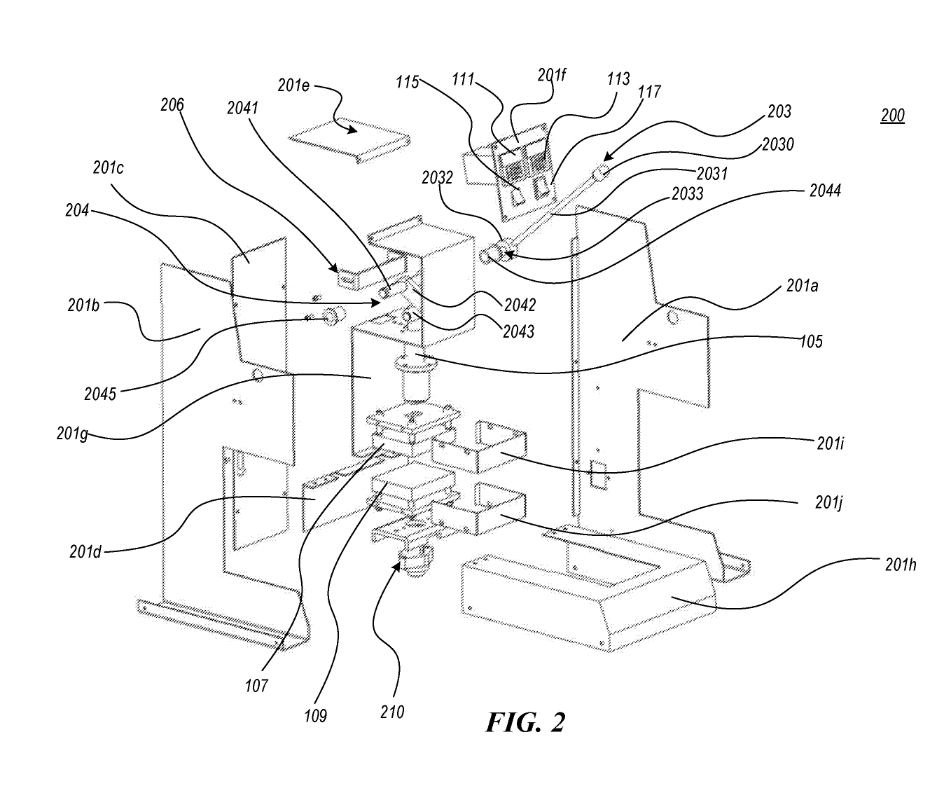

FIG. 1 is an isometric view of an apparatus 100 configured in accordance with representative embodiments of the present technology. The apparatus 100 can include a housing 101, a handle 103, a pressure component 105, a first heating component 107 coupled to the pressure component 105, and a second heating component 109. The housing 101 is configured to at least partially accommodate and/or protect the other components/elements of the apparatus 100, The handle 103 is coupled to the pressure component 105 via a linkage component (which is not visible in FIG. 1 and will be discussed below in detail with reference to FIGS. 2-4B). A user of the apparatus 100 can hold and then move/rotate the handle 103 so as to cause the pressure component 105 to move (e.g., in the vertical direction of FIG. 1). When the pressure component 105 is moved, the first heating component 107 coupled to the pressure component is moved accordingly. The pressure component 105 is also configured to apply a continuous force on the first heating component 107, such that a material to be heat-pressed positioned between the first heating component 107 and the second heating component 109 can be heat-pressed under pre-determined conditions (e.g., at specific temperature, under particular pressure, and/or force profile). In some embodiments, the pressure component 105 can include a cylinder, a spring, and/or other suitable components that can provide a desired force.

In some embodiments, the first and second heating components 107, 109 can be made of metal or other suitable thermal-conductive materials. In some embodiments, the first and second heating components 107, 109 can be heated by electricity, gas, and/or other suitable energy sources. For example, the first and second heating components 107, 109 can include one or more resistive heaters, Peltier devices, gas heaters, or combinations thereof. In some embodiments, the surfaces 108, 110 of the respective first and second heating components 107, 109 can include patterns that can (1) facilitate the heat-press process (e.g., by increasing friction between the surfaces 108, 110 and an object or a material to be heat-pressed) and/or (2) generate a heat-press mark on an object or a material to be heat-pressed. Increased friction can reduce or limit movement of the objective material. In some embodiments, the first and second heating components 107, 109 can be made of different materials and/or have different patterns. In other embodiments, the surface 108, 110 can be generally smooth to provide uniform pressure to the object or material to be heat-pressed.

As shown in FIG. 1, the apparatus 100 can include a first control/display panel 111 and a second control/display panel 113. In the illustrated embodiments, the first control/display panel 111 is configured to control and display the temperature of the first heating component 107. The second control/display panel 113 is configured to control and display the temperature of the second heating component 109. In some embodiments, the first control/display panel 111 and the second control/display panel 113 can be integrated as one control/display panel. In some embodiments, the temperatures of the first and second heating components 107, 109 can be controlled and/or monitored by a remote device (e.g., a smartphone with a software application installed). In some embodiments, the apparatus 100 can include addition control/display panels configured to control and display other parameters (e.g., pressure, locations, rotation angles, etc.) of the first/second heating components 107, 109, surfaces 108, 110, etc. As shown in FIG. 1, the apparatus 100 can include a power connector 119 configured to be coupled with an external power source. In some embodiments, the apparatus 100 can include an internal power source (e.g., a power generator, a battery, etc.).

As shown in FIG. 1, the apparatus 100 can include a first control switch 115 positioned adjacent to the first control/display panel 111 and a second control switch 117 positioned adjacent to the second control/display panel 113. The first control switch 115 enables a user to turn on/off the first heating component 107, and the second control switch 117 enables the user to turn on/off the second heating component 109. By this arrangement, the user can determine whether a heat-press process needs heat from either one of the first/second heating components 107, 109 or both.

In some embodiments, the apparatus 100 can include a protective component 121 positioned adjacent to the first/second heating components 107, 109. The protective component 121 is configured to prevent a user from reaching the first/second heating components 107, 109 during a heat-press process. In some embodiments, the protective component 121 can be made of a transparent material such as plastic, glass, resin, etc. In some embodiments, the protective component 121 can completely surround the space where the first/second heating components 107, 109 operate or a gap 118 between the first and second components 107, 109. In such embodiments, a user may need to open or remove the protective component 121 so as to put a material to be heat-pressed in (or remove a heat-pressed material from) the gap 118. In some embodiments, the protective component 121 can be shaped or formed in accordance with the shape of the housing 101 (e.g., to make the apparatus have an overall seamless shape or smooth appearance).

In some embodiments, the apparatus 100 can also include a processor, a controller, and/or a computer configured to control other components of the apparatus 100. In some embodiments, the apparatus 100 can further include a memory, a storage device (hard drive, flash drive, etc.), and/or other suitable device configured to temporarily or permanently store data or information (e.g., operation parameters/logs, materials that have been heat-pressed, etc.) associated with the apparatus 100. In some embodiments, the stored data or information can be transmitted to a remote device (e.g., a smartphone, a computer, a portable device, a database, etc.).

The apparatus 100 can contain computer- or controller-executable instructions, including routines executed by a programmable computer or controller. Those skilled in the relevant art will appreciate that the technology can be practiced on computer or controller systems other than those shown and described below. The technology can be embodied in a special-purpose computer or data processor that is specifically programmed, configured or constructed to perform one or more of the computer-executable instructions described below. Accordingly, the terms “computer” and “controller” as generally used herein refer to any suitable data processor and can include Internet appliances and handheld devices (including palm-top computers, wearable computers, cellular or mobile phones, multi-processor systems, processor-based or programmable consumer electronics, network computers, mini computers, a programmed computer chip, and the like). Information handled by these computers and controllers can be presented at any suitable display medium, including a CRT display or an LCD. For example, the first and second control/display panels 111, 113 can include LCDs. Instructions for performing computer- or controller-executable tasks can be stored in or on any suitable computer-readable medium, including hardware, firmware or a combination of hardware and firmware. Instructions can be contained in any suitable memory device, including, for example, a flash drive, USB device, or other suitable medium. In particular embodiments, the term “component” can include hardware, firmware, or a set of instructions stored in a computer-readable medium.

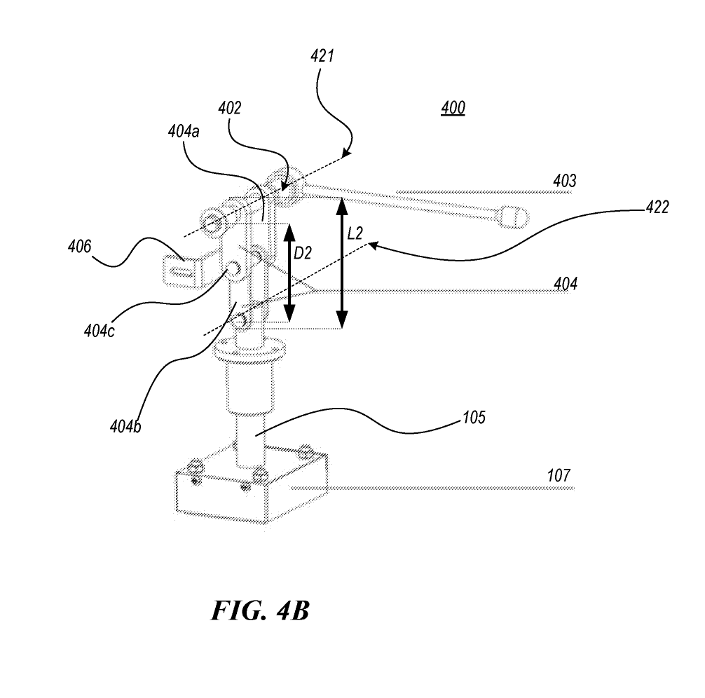

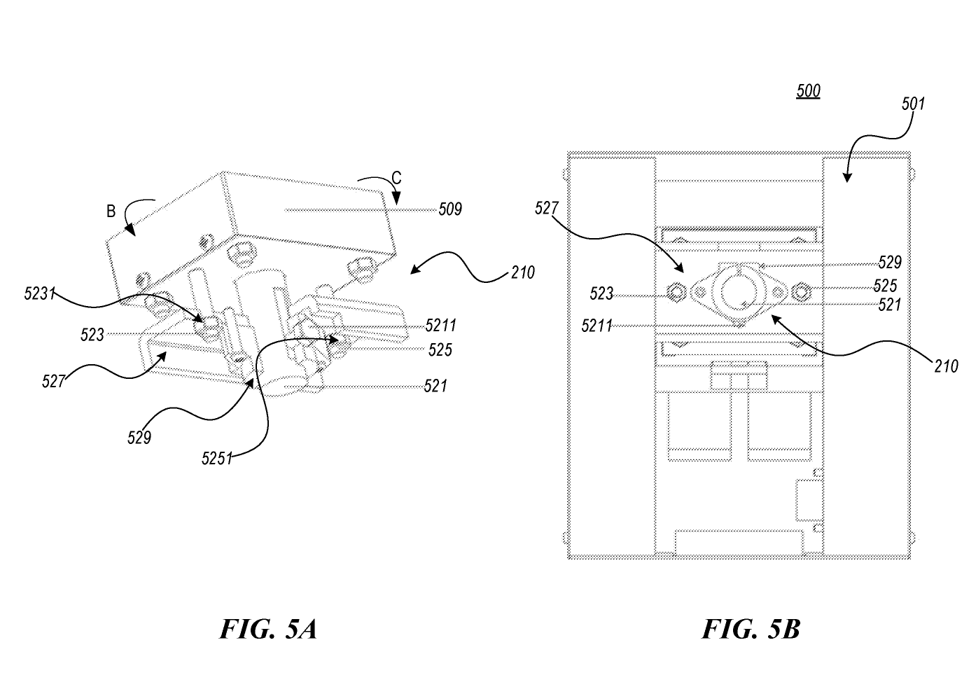

FIG. 2 is an exploded view of an apparatus 200 configured in accordance with representative embodiments of the present technology. The relevant description of the apparatus 100 applies to the apparatuses 200. The apparatus 200 can include a housing 201 (shown as housing components 201a-201j in FIG. 2), a handle 203, a linkage assembly or component 204 (“linkage component 204”) coupled to the handle 203 by a connector 2041 (e.g., an elongated member, a pin, etc.), a pressure component 105, a positioning component 206, a first heating component 107 coupled to the pressure component 105, a second heating component 109, and an adjustable supporting component 210 (to be discussed in detail below with reference to FIG. 5A) coupled to the second heating component 109.

As shown in FIG. 2, the housing 201 includes (1) a first side housing component 201a, (2) a second side housing component 201b opposite to the first housing 201a, (3) an upper back housing component 201c, (4) a lower back housing component 201d, (5) a top housing component 201e, (6) an upper front housing component 201f, (7) a middle front housing component 201g, (8) a lower front housing component 201h, (9) a first cover component 201i configured to accommodate the first heating component 107, and (10) a second cover component 201j configured to accommodate the second heating component 109. The first and second heating components 107, 109 can include one or more electric heaters, such as resistive heaters. The housing components 201a-j are configured to at least partially accommodate and/or protect the other components/elements of the apparatus 200.

In the illustrated embodiments, the middle front housing component 201g is configured to cover the linkage component 204 and a portion of the pressure component 105. With this arrangement, the pressure component 105 can be easily reached from the outside of the housing 201, which provides a convenient access to the pressure component 105 when it needs to be maintained or replaced. In other embodiments, however, the housing components 201a-j can have different configurations depending on various design needs.

As shown in FIG. 2, the handle 203 includes a knob 2030, a rod 2031, and a handle connector 2032. The handle connector 2032 has a hole 2033 configured to accommodate a portion of the connector 2041. In the illustrated embodiments, the handle 203 and the linkage component 204 are coupled by inserting the connector 2041 into the hole 2031. In other embodiments, the handle 203 and the linkage component 204 can be coupled by other suitable means.

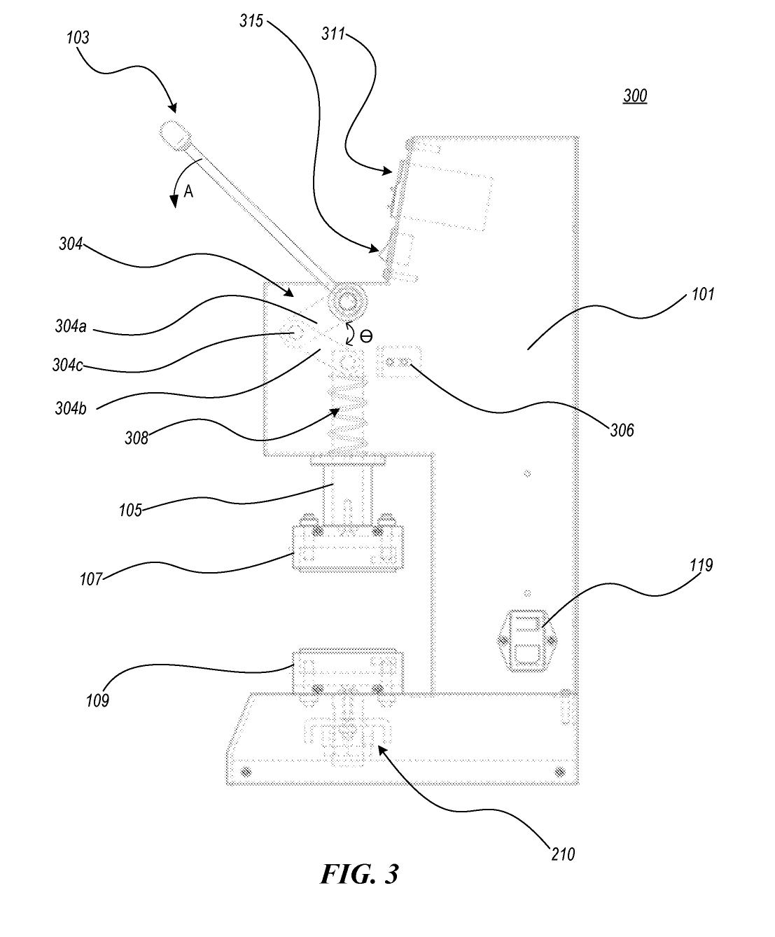

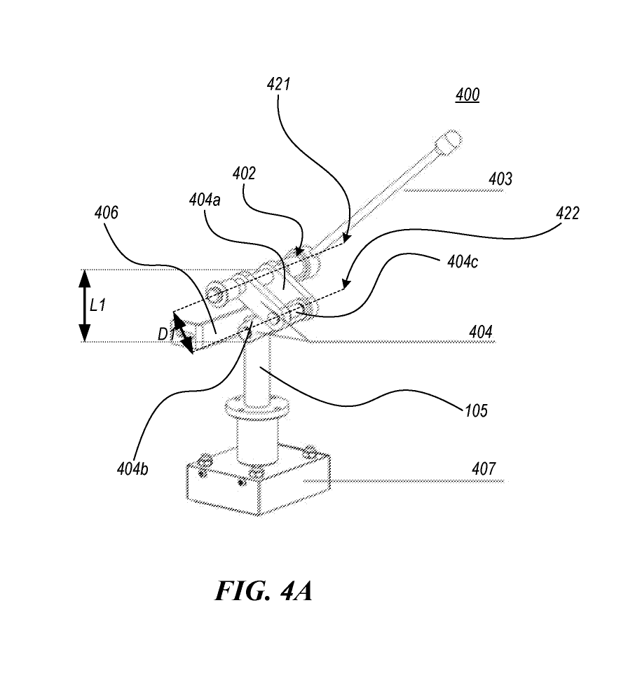

As shown in FIG. 2, the linkage component 204 can further include a first linkage member 2042, a second linkage member 2043, a first sleeve component 2044, and a second sleeve component 2045. As shown, the first linkage member 2042 is rotatably coupled to the second linkage member 2043 (operations regarding the first/second linkage members 2042, 2043 will be discussed in detail below with reference to FIGS. 3-4B). The first linkage member 2042 is coupled to the handle 203 via the connector 2041. The first/second sleeve components 2044, 2045 are positioned on both sides of the linkage component 204 and configured to be fixedly coupled to the first side housing component 201a and the second side housing component 201b, respectively. The first/second sleeve components 2044, 2045 are also rotatably coupled to the connector 2041. The second linkage member 2043 is further coupled to the pressure component 105. The pressure component 105 is coupled to the first heating component 107. The pressure component 105 is configured to apply a continuous force on the first heating component 107, such that a material to be heat-pressed positioned between the first heating component 107 and the second heating component 109 can be heat-pressed under one or more pre-determined conditions. In some embodiments, the pressure component 105 can include a cylinder, a spring, and/or other suitable components that can provide a desired force (e.g., variable force, constant force, etc.).

As shown, the positioning component 206 (e.g., a stopper, a guiding rail, an aligning component, and/or other suitable devices) is positioned adjacent to the linkage component 204 and configured to position the linkage component 204. A user can control the apparatus 200 via the handle 203. By moving and/or rotating the handle 203, the linkage component 204 can be moved between a first position and a second position (embodiments regarding the first/second positions will be discussed below with reference to FIGS. 4A and 4B).

When the linkage component 204 is at the first position (e.g., FIG. 4B), the apparatus 200 allows the user to put a material to be heat-pressed in the apparatus (or remove a heat-pressed material therefrom). The positioning component 206 is configured/positioned to make sure that the linkage component 204 is at the second position. When the linkage component 204 is at the second position (e.g., FIG. 4A), the linkage component 204 can continuously apply a force on the pressure component 105. Accordingly, the first heating component 107 coupled to the pressure component 105 is moved toward the second heating component 109 and then a material positioned therebetween can be heat-pressed. As a result, the user does not need to keep pressing the handle 203 during the heat-press process. The positioning component 206 maintains the location of the linkage component 204, and accordingly the pressure component 105 can continuously provide suitable forces on the material to be heat-pressed.

In some embodiments, the first and second heating components 107, 109 can be made of metal or other suitable thermal-conductive materials. In some embodiments, the first and second heating components 107, 109 can be heated by electricity, gas, and/or other suitable energy sources. In some embodiments, the surfaces of the first and second heating components 107, 109 can include patterns that can (1) facilitate the heat-press process and/or (2) generate a heat-press mark on an object or a material to be heat-pressed. In some embodiments, the first and second heating components 107, 109 can be made of different materials and/or have different patterns.

In the illustrated embodiments, the second heating component 109 is coupled to and supported by the adjustable supporting component 210. The adjustable supporting component 210 is configured to adjust the position of the second heating component 109 such that the apparatus 200 can perform a heat-press process at a pre-determined operating condition. For example, by adjusting the location of the second heating component 109, the apparatus 200 can control a heat-press process under a specific pressure (or in a particular pressure range). Having such flexibility is beneficial at least because it enables a user to customize various heat-press processes for different types of materials to be heat-pressed (or different volumes of a same material to be heat-pressed). Embodiments of the adjustable supporting component 210 will be discussed in detail below with reference to FIG. 5A.

As also shown in FIG. 2, the apparatus 200 includes a first control/display panel 111 and a second control/display panel 113 position on the upper front housing component 201f. In the illustrated embodiment, the first control/display panel 111 is configured to control and display the temperature of the first heating component 107. The second control/display panel 113 is configured to control and display the temperature of the second heating component 109. In some embodiments, the first control/display panel 111 and the second control/display panel 113 can be integrated as one control/display panel.

The apparatus 200 also includes a first control switch 115 positioned adjacent to the first control/display panel 111 and a second control switch 117 positioned adjacent to the second control/display panel 113. The first control switch 115 enables a user to turn on/off the first heating component 107, and the second control switch 117 enables the user to turn on/off the second heating component 109. By this arrangement, the user can determine whether a heat-press process needs heat from either one of the first/second heating components 107, 109 or both.

FIG. 3 is a side view illustrating an apparatus 300 configured in accordance with representative embodiments of the present technology. The apparatus 300 can include a housing 101, a handle 103, a linkage component 304, a pressure component 105 coupled to the linkage component 304, a positioning component 306 positioned adjacent to the linkage component 304, a biasing element or resilient component 308 (“resilient component 308”) positioned adjacent to the pressure component 105, a first heating component 107 coupled to the pressure component 105, a second heating component 109, and an adjustable supporting component 210 coupled to the second heating component 109. The housing 101 is configured to at least partially accommodate and/or protect the other components/elements of the apparatus 300. The handle 103 is coupled to the pressure component 105 via the linkage component 304 and enables a user to move the linkage component 304.

As shown in FIG. 3, the linkage component 304 includes a first linkage member 304a, a second linkage member 304b, and a connecting member 304c. As shown, the first linkage member 304a is rotatably coupled to the second linkage member 304b via the connecting member 304c. The first linkage member 304a is coupled to the handle 103, and accordingly a user can control the apparatus 300 via the handle 103. The second linkage member 304b is coupled to the pressure component 105 and the pressure component 105 is further coupled to the first heating component 107. The pressure component 105 is configured to apply a continuous force on the first heating component 107, such that a material to be heat-pressed positioned between the first heating component 107 and the second heating component 109 can be heat-pressed under pre-determined conditions.

By moving and/or rotating the handle 103, the linkage component 304 can be moved between a first position (e.g., as shown in FIG. 3 and FIG. 4B) and a second position (e.g., as the embodiments shown in FIG. 4A). When the linkage component 304 is at the first position, the apparatus 300 allows the user to put a material to be heat-pressed in the apparatus 300 (or remove a heat-pressed material therefrom). As shown in FIG. 3, the first linkage member 304a and the second linkage member 304b are positioned to form an acute angle θ. In other embodiments, however, the first linkage member 304a and the second linkage member 304b can be positioned to form a right angle or an obtuse angle.

As shown, the positioning component 306 (e.g., a stopper, a guiding rail, an aligning component, and/or other suitable devices) is positioned adjacent to the linkage component 304 and configured to position the linkage component 304. In the illustrated embodiments, when a user rotates the handle 103 (e.g., in the counterclockwise direction A shown in FIG. 3), the positioning component 306 acts as a stopper to stop the rotation/movement of the second linkage member 304b and make sure that the linkage component 304 is at the second position (e.g., where the first linkage member 304a and the second linkage member 304b together form a 180-degree angle). In some embodiments, the positioning component 306 can be positioned to stop the rotation/movement of the first linkage member 304b or the connecting member 304c.

When the linkage component 304 is at the second position (e.g., as the embodiments shown in FIG. 4A), the linkage component 304 can continuously apply a force on the pressure component 105. Accordingly, the first heating component 107 coupled to the pressure component 105 is moved toward the second heating component 109 and then a material positioned therebetween can be heat-pressed. By this arrangement, the user does not need to keep pressing the handle 103 during the heat-press process. The positioning component 306 maintains the location of the linkage component 304, and accordingly the pressure component 105 can continuously provide suitable forces on the material to be heat-pressed. In some embodiments, the pressure component 105 can include a cylinder, a spring, and/or other suitable components that can provide a continuous force.

In the illustrated embodiments, the resilient component 308 is configured to provide additional forces to facilitate operation of the apparatus 300. The resilient component 308 can include one or more springs (e.g., helical springs, coil springs, compression spring, tension spring, etc.) that can exert an opening or closing force. For example, the resilient component 308 can be a spring capable of exerting a biasing force sufficient to keep the pressure component 105 in the raised position. A user can overcome the biasing force to reconfigure the linkage component 304 to lower the pressure component 105. When a heat-press process is completed, a user can slightly move the handle 103 (e.g., accordingly, the first linkage member 304a and the second linkage member 304b no longer form a 180-degree angle), then the compressed resilient component 308 can move the linkage member 304 back to the first position. In other embodiment, the biasing component 308 shown in FIG. 3 can provide a biasing force for urging the pressure component 105 to the lowered position. The user can rotate the handle 103 clockwise to overcome the biasing force to move the linkage component 304 from the second configuration to the first configuration. The position, configuration, and number of biasing elements or components can be selected based on the desired operation of the system 300.

As shown in FIG. 3, the apparatus 300 includes a control/display panel 311 configured to control and display the temperatures of the first/second heating components 107, 109. As shown, the apparatus 300 includes a control switch 315 positioned adjacent to the control/display panel 311. The control switch 315 enables a user to turn on/off the first/second heating components 107, 109. The apparatus 300 also includes a power connector 119 configured to be coupled with an external power source. In some embodiments, the apparatus 300 can include an internal power source (e.g., a power generator, a battery, etc.).

FIGS. 4A and 4B are partial, isometric views illustrating operations of an apparatus 400 configured in accordance with representative embodiments of the present technology. The apparatus 400 includes a handle 403, a first connector 402a coupled to the handle 403, a linkage component 404 (which includes a first linkage member 404a, a second linkage member 404b, and a connecting member 404c) coupled to the first connector 402a, a second connector 402b coupled to the linkage component 404, a pressure component 105 coupled to the linkage component 404 via the second connector 402b, an aligning component 406, and a heating component 107 coupled to the pressure component 105.

As shown in FIGS. 4A and 4B, the handle 403 is coupled to the first linkage member 404a via the first connector 402a. In some embodiments, the first connector 402a can include a set of gears positioned therein. In the illustrated embodiments, the first linkage member 404a includes two parallel elongated members. In other embodiments, the first linkage member 404a can include only one elongated member (or more than two elongated members). The first linkage member 404a is rotatably coupled to the second linkage member 404b via the connecting member 404c. In the illustrated embodiments, the second linkage member 404b includes two parallel elongated members. In other embodiments, the second linkage member 404b can include only one elongated member (or more than two elongated members).

In the illustrated embodiments, the connecting member 404c is an elongated member that can be accommodated by holes of the first/second linkage members 404a, 404b. In other embodiments, the connecting member 404c can include a bearing, a set of gears, or other suitable devices that can facilitate rotation between the first/second linkage members 404a, 404b.

A user of the apparatus 400 can hold and move/rotate the handle 403 to move the linkage component 404 between a first position and a second position. In FIG. 4B, the linkage component 404 is at the first position and the apparatus 400 allows a user to put a material to be heat-pressed adjacent to the heating component 107 (or remove a heat-pressed material therefrom). In FIG. 4A, the linkage component 404 is at the second position, and the linkage component 404 can continuously apply a force on the pressure component 105. Accordingly, the heating component 107 coupled to the pressure component 105 is moved and then the material positioned adjacent to the heating component 107 can be heat-pressed. As shown in FIG. 4A, the aligning component 406 is configured to position the linkage component 404 at the second positon.

The linkage component 404 has a first length L1 (as shown in FIG. 4A) when the linkage component 404 is at the first position. The linkage component 404 has a second length L2 (as shown in FIG. 4B) when the linkage component 404 is at the second position. The second length L2 is greater than the first length L1. In some embodiments, the first connector 402a rotatably couples the first linkage member 404a to the handle 403 and defines a first axis of rotation 421. The second connector 402b rotatably couples the second linkage member 404b to the pressure component 105, and defines a second axis of rotation 422. The first and second axes of rotation are separated by a first distance D1 (as shown in FIG. 4A) when the linkage component 404 is at the first position. The first and second axes of rotation are separated by a second distance D2 (as shown in FIG. 4B) when the linkage component 404 is at the second position. The second distance D2 is greater than the first distance D1, and the difference between the first and second distances D1 and D2 corresponds to the distance of travel of the pressure component 107. The number and positions of the linkage members and connectors can be selected based on the desired length of travel of the pressure component 107, user force required for operating the apparatus 400, etc.

FIG. 5A is an isometric view of an adjustable supporting component 210 and a heating component 509 configured in accordance with representative embodiments of the present technology. FIG. 5B is a bottom view of an apparatus 500 having the adjustable supporting component 210 and the heating component 509 shown in FIG. 5A. The adjustable supporting component 210 can be operated to move the heating component 509 and can include a post 521 coupled to the heating component 509. The adjustable supporting component 210 further includes a platform 527 fixedly attached to a housing 501 of the apparatus 500. (In the isometric view of FIG. 5A, the platform 527 is shown as a cut-out component only to provide a clearer view of the components positioned adjacent thereto.) The platform 527 is coupled to a clamping component 529. The clamping component 529 and the platform 527 together define a center opening that can accommodate the post 521.

The adjustable supporting component 210 further includes a guide bolt 5211 configured to be selectively in contact with the post 521. When the guide bolt 5211 is in contact with the post 521, the post 521 is fixed and cannot move relative to the platform 527. When the guide bolt 5211 is not in contact with the post 521, the post 521 can be (e.g., vertically) moved by a user in the center opening, which accordingly enables the user to adjust the (e.g., vertical) position of the heating component 509.

The adjustable supporting component 210 also includes a first bolt 523 and a second bolt 525 positioned opposite to the first bolt 523. The first bolt 523 and the second bolt 525 are both coupled to the heating component 509. The platform 527 includes a first opening configured to accommodate the first bolt 523 and a second opening configured to accommodate the second bolt 525. The first bolt 523 is coupled to the platform 527 via a first nut 5231, and the second bolt 525 is coupled to the platform 527 via a second nut 5251. By adjusting (e.g., rotating) the first/second bolts 5231, 5251, a user can adjust the (e.g., horizontal) position of the heating component 509. For example, when a user adjusts the first nut 5231 to decrease the distance between the platform 527 and the heating component 509, the heating component 509 can accordingly rotate in direction B. Similarly, when a user adjusts the second nut 5251 to decrease the distance between the platform 527 and the heating component 509, the heating component 509 accordingly rotates in direction C. By this arrangement, the user can effectively adjust or fine-tune the (e.g., horizontal) position of the heating component 509.

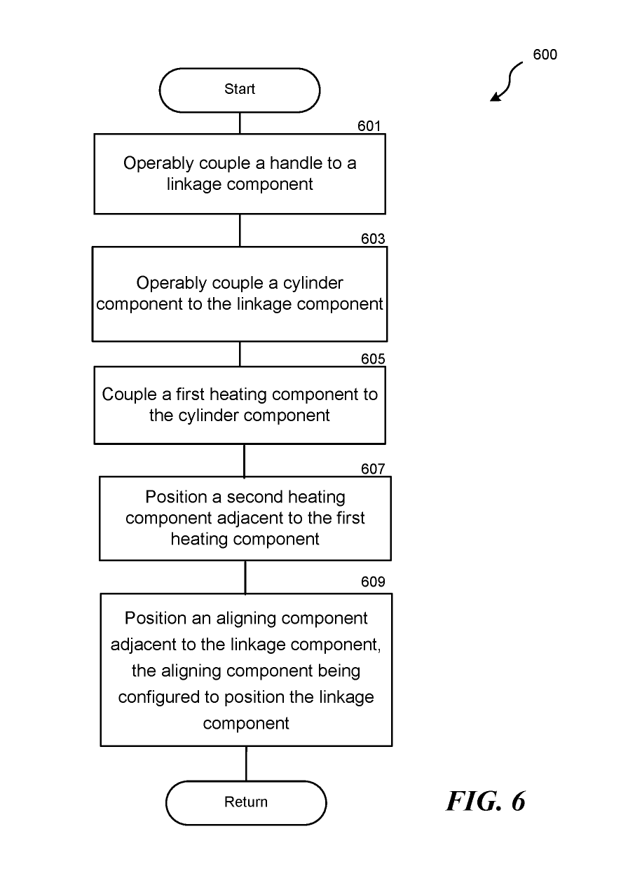

FIG. 6 is a flowchart illustrating a method 600 in accordance with representative embodiments of the present technology. The method 600 can be implemented to manufacture an apparatus (e.g., the apparatus 100, 200, 300, 400 or 500 discussed above) in accordance with the present technology. At block 601, the method 600 includes operably coupling a handle to a linkage component. The linkage component is movable between a first position and a second position. At block 603, the method 600 continues to operably couple a cylinder component to the linkage component. In some embodiments, the cylinder component can be replaced by a pressure component or other suitable components. The method 600 continues, at block 605, by coupling a first heating component to the cylinder component. At block 607, the method 600 then positions a second heating component adjacent to the first heating component. At block 609, the method 600 then positions an aligning component adjacent to the linkage component. The aligning component is configured to position or align the linkage component. The method 600 then returns for further instructions.

In some embodiments, the method 600 can include performing an alignment test of the first linkage member and second linkage member. The alignment test can include measuring an angle formed by the first linkage member and second linkage member when the aligning component is in contact with the linkage component. For example, if the result of the alignment test indicates that the first linkage member and second linkage member can form a 180-degree angle when the aligning component is in contact with the linkage component, then the alignment test is passed. In cases where an apparatus fails to pass the alignment test, the method 600 can move the process back to block 609 to re-position the alignment component.

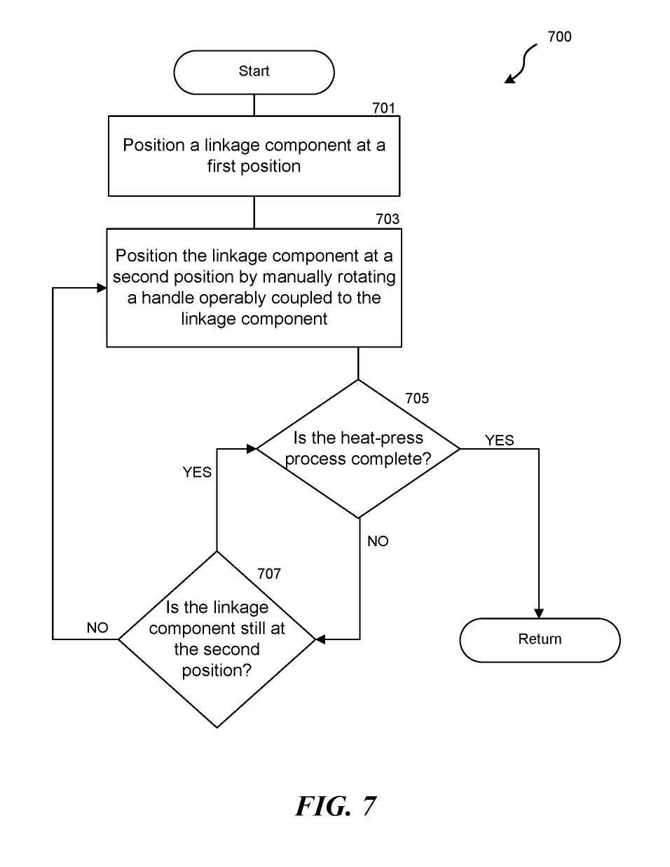

FIG. 7 is a flowchart illustrating a method 700 in accordance with representative embodiments of the present technology. The method 700 can be implemented to operate an apparatus (e.g., the apparatus 100, 200, 300, 400 or 500 discussed above) in accordance with the present technology. At block 701, the method 700 starts by positioning a linkage component at a first position. At block 703, the method 700 positions the linkage component at a second position by manually rotating a handle operably coupled to the linkage component. When the linkage component is at the second position, the linkage component is in contact with an aligning component positioned adjacent to the linkage component. The aligning component is positioned to support, position, and/or limit movement of the linkage component. The linkage components or assemblies can be replaced with other suitable component/devices to provide different closed positions.

At decision block 705, the method 700 determines whether the heat-press process is complete. If so, then the process returns for further instructions. If not, then the process moves to decision block 707 to determine if the linkage component is still at the second position. At decision block 707, if the determination is positive, then the process moves back to decision block 705. In some embodiments, the method 700 can wait for a period of time (e.g., 1-10 minutes) before turning the process back to decision block 705.

At decision block 707, if the determination is negative, then the process moves back to block 703 and the method 700 will request a user to re-position the linkage component at the second position (e.g., sending a visual/audio/tactile signal to a user). In some embodiments, the determination made at decision block 707 can be performed by a thermal (or pressure) sensor coupled to the first heating component (or the second heating component).

From the foregoing, it will be appreciated that specific embodiments of the technology have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall with within the scope of the present technology. Accordingly, the present disclosure and associated technology can encompass other embodiments not expressly shown or described herein.

I/we claim:

1. An apparatus for pressing and heating a material, the apparatus comprising;
a handle;
a linkage assembly operably coupled to the handle, the linkage assembly being movable between a first configuration and a second configuration, the linkage assembly having a first length when the linkage component is in the first configuration, the linkage component having a second length when the linkage component is in the second configuration, the second length being greater than the first length;
a pressure component operably coupled to the linkage assembly;
a first heating component coupled to the pressure component;
a second heating component positioned adjacent to the first heating component; and
a positioning component positioned adjacent to the linkage assembly and configured to position the linkage assembly in the second configuration;
wherein, when the linkage assembly moves toward the second configuration, the linkage assembly drives the pressure component toward the second heating component, and the linkage assembly in the second configuration holds the pressure component stationary relative to the second heating component without requiring a user to hold the handle.

2. The apparatus of claim 1, wherein the linkage assembly includes a first linkage member and a second linkage member coupled to the first linkage member, and wherein the first linkage member is operably coupled to the handle, and wherein the second linkage member is operably coupled to the pressure component.

3. The apparatus of claim 2, wherein the linkage assembly includes a connecting member positioned to adjust an angle formed by the first linkage member and the second linkage member.

4. The apparatus of claim 3, wherein the connecting member includes a set of gears.

5. The apparatus of claim 3, wherein when the linkage assembly is in the second configuration, the connecting member is in contact with the positioning component.

6. The apparatus of claim 2, wherein when the linkage assembly is in the second configuration, the first linkage member is in contact with the positioning component.

7. The apparatus of claim 2, wherein when the linkage assembly is in the second configuration, the second linkage member is in contact with the positioning component.

8. The apparatus of claim 2, wherein when the linkage assembly is in the second configuration, the first linkage member and the second linkage member are positioned to form a substantially straight line.

9. The apparatus of claim 2, wherein when the linkage assembly is in the first configuration, the first linkage member and the second linkage member are positioned to form an acute angle.

10. The apparatus of claim 2, wherein when the linkage assembly is in the first configuration, the first linkage member and the second linkage member are positioned to form a substantial right angle.

11. The apparatus of claim 2, wherein when the linkage assembly is in the first configuration, the first linkage member and the second linkage member are positioned to form an obtuse angle.

12. The apparatus of claim 1, further comprising a housing positioned to accommodate the linkage assembly.

13. The apparatus of claim 1, wherein the positioning component includes a stopper.

14. The apparatus of claim 1, wherein the second heating component is positioned below the first heating component, and wherein the apparatus further comprises an adjustable supporting component coupled to the second heating component and configured to adjust a position of the second heating component.

15. The apparatus of claim 1, further comprising a resilient component positioned adjacent to the pressure component.

16. A method for manufacturing a heat-press apparatus, the method comprising:
operably coupling a handle to a linkage component, the linkage component being movable between a first position and a second position, the linkage component having a first length when the linkage component is at the first position, the linkage component having a second length when the linkage component is at the second position, the second length being greater than the first length;
operably coupling a cylinder component to the linkage component;
coupling a first heating component to the cylinder component;
positioning a second heating component adjacent to the first heating component; and
positioning an aligning component adjacent to the linkage component, the aligning component being configured to position the linkage component at the second positon;
wherein, when the linkage component is at the second position, the linkage component drives the cylinder component toward the second heating component, and the linkage component at the second position holds the cylinder component stationary relative to the second heating component without requiring a user to hold the handle.

17. The method of claim 16, wherein the linkage component includes a first linkage member and a second linkage member coupled to the first linkage member, and wherein the method further comprises:
operably coupling the first linkage member to the handle; and
operably coupling the second linkage member to the cylinder component.

18. The method of claim 17, further comprising performing an alignment test of the first linkage member and second linkage member, wherein the alignment test includes measuring an angle formed by the first linkage member and second linkage member when the aligning component is in contact with the linkage component.

19. A method for operating a heat-press apparatus, the method comprising:
positioning a linkage component at a first position, the linkage component having a first length when the linkage component is at the first position; and
positioning the linkage component at a second position by manually rotating a handle operably coupled to the linkage component, the linkage component having a second length when the linkage component is at the second position, the second length being greater than the first length;
wherein, when the linkage component is at the second position, the linkage component is in contact with an aligning component positioned adjacent to the linkage component;
wherein the aligning component is positioned to support the linkage component; and
wherein, when the linkage component is at the second position, the linkage component drives a cylinder component coupled to a first heating component toward the second heating component, and the linkage component at the second position holds the cylinder component stationary relative to the second heating component without requiring a user to hold the handle.

20. The method of claim 19, wherein the linkage component includes a first linkage member and a second linkage member coupled to the first linkage member, and wherein the method further comprises:
when the linkage component is at the first position, positioning the first linkage member and the first linkage member to form a non-180-degree angle; and
when the linkage component is at the second position, positioning the first linkage member and the first linkage member to form a substantially straight line.
